(19) United States
(12) Patent Application Publication
(10) Pub. No.: US 2011/0195657 A1
(43) Pub. Date: Aug. 11, 2011

(54) RADIO RELAY APPARATUS

(75) Inventors: Daisuke Takeda, Kawasaki-shi (JP); Ren Sakata, Yokohama-shi (JP); Noritaka Deguchi, Yokohama-shi (JP); Mototaka Kitajima, Tachikawa-shi (JP)

(73) Assignee: KABUSHIKI KAISHA TOSHIBA

(21) Appl. No.: 13/020,885

(22) Filed: Feb. 4, 2011

(30) Foreign Application Priority Data
Feb. 10, 2010 (JP) 2010-028114

(51) Int. Cl. H04B 3/36

(52) U.S. Cl. 455/7

(57) ABSTRACT

According to one embodiment, a radio relay apparatus includes a reception unit, a cancellation unit, a weight calculation unit, and a weight multiplication unit. The reception unit generates M first baseband signals based on M first RF signals supplied by M reception antennas. The cancellation unit subtracts M replicated signals replicating loop interference signals in the M reception antennas, from the respective M first baseband signals, to obtain M second baseband signals. The weight calculation unit calculates M×M weights corresponding to M×M loop interference channels. The weight multiplication unit multiplies the M second baseband signals by the M weights corresponding to the respective M reception antennas and then combines resultant signals together to obtain M replicated signals to be supplied to the cancellation unit.

### CROSS-REFERENCE TO RELATED APPLICATIONS

This application is based upon and claims the benefit of priority from Japanese Patent Application No. 2010-028114, filed Feb. 10, 2010; the entire contents of which are incorporated herein by reference.

### FIELD

Embodiments described herein relate generally to a technique to cancel a loop interference wave in a radio relay apparatus.

### BACKGROUND

A radio relay apparatus (repeater) amplifies a signal received from a relay source (master station) and transmits the amplified signal to a relay destination (slave station). The signal transmitted by the repeater is received not only by the relay destination but also by the repeater itself. The signal transmitted by the repeater and received by the repeater itself is called a loop interference wave. When the loop interference wave is repeatedly amplified by the repeater, the system may disadvantageously be oscillated. This problem is significant when reception and transmission (relaying) are performed in the same frequency band in order to increase frequency utilization efficiency.

For example, a loop interference canceller described in JP-A H11-355160 (KOKAI) and a loop interference cancellation apparatus described in JP-A 2003-8489 (KOKAI) are utilized to deal with the loop interference wave. The loop interference canceller described in JP-A H11-355160 (KOKAI) cancels a loop interference wave contained in a signal received by one reception antenna, and transmits the resultant signal by one transmission antenna. The loop interference cancellation apparatus described in JP-A 2003-8489 (KOKAI) cancels each of the loop interference waves contained in the respective signals received by a plurality of reception antennas, combines the resultant signals together, and transmits the obtained signal by one transmission antenna.

Radio communication systems utilizing repeaters typically include a terrestrial digital broadcasting system and a 2G/3G system. These radio communication systems each transmit signals in a single stream. On the other hand, 3GPP Long Term Evolution (LTE), for which service will be started in the near future, enables signals to be transmitted in a plurality of streams. Here, radio communication in a single stream is called single-input single-output (SISO) communication. On the other hand, in the description below, radio communication in a plurality of streams is called multiple-input multiple-output (MIMO) communication.

Neither the loop interference canceller described in JP-A H11-355160 (KOKAI) nor the loop interference cancellation apparatus described in JP-A 2003-8489 (KOKAI) is expected to be utilized in a MIMO communication system. Even when an attempt is made to arrange a plurality of repeaters incorporating these cancellers or cancellation apparatuses so as to relay streams in the MIMO communication system, each of the repeaters may cancel the loop interference wave from the repeater itself but fails to cancel loop interference waves from other repeaters. That is, the conventional repeaters cannot sufficiently cancel loop interface waves during the relaying of MIMO communication. Thus, the system may be oscillated.

### BRIEF DESCRIPTION OF THE DRAWINGS

FIG. 1 is a block diagram showing a radio relay apparatus according to a first embodiment;

FIG. 2 is a diagram showing a radio communication system including the radio relay apparatus shown in FIG. 1;

FIG. 3 is a block diagram showing a weight calculation unit shown in FIG. 1;

FIG. 4 is a block diagram showing a weight multiplication unit shown in FIG. 1;

FIG. 5 is a block diagram showing a weight calculation unit according to a second embodiment;

FIG. 6 is a diagram showing a frame format for 3GPP-LTE;

FIG. 7 is a block diagram showing a radio relay apparatus according to a fourth embodiment;

FIG. 8 is a block diagram showing a weight calculation unit shown in FIG. 7;

FIG. 9 is a block diagram showing a combiner weight calculation unit shown in FIG. 7;

FIG. 10 is a block diagram showing a radio relay apparatus according to a fifth embodiment;

FIG. 11 is a block diagram showing a weight calculation unit shown in FIG. 10;

FIG. 12 is a block diagram showing a weight multiplication unit shown in FIG. 10; and

FIG. 13 is a block diagram showing a radio relay apparatus according to a sixth embodiment.

### DETAILED DESCRIPTION

Embodiments will be described below with reference to the drawings.

In general, according to one embodiment, a radio relay apparatus receives a target signal with N (N≧1) streams from a first radio communication apparatus via M (M≧2) reception antennas and transmits the target signal to a second radio communication apparatus via M transmission antennas. The apparatus includes a reception unit, a cancellation unit, a transmission unit, a weight calculation unit, and a weight multiplication unit. The reception unit generates M first baseband signals based on M first RF signals supplied by the M reception antennas. The cancellation unit subtracts M replicated signals replicating loop interference signals in the M reception antennas, from the respective M first baseband signals, to obtain M second baseband signals. The transmission unit generates M second RF signals based on the M second baseband signals and supplies the M second RF signals to the M transmission antennas, respectively. The weight calculation unit calculates M×M weights corresponding to M×M loop interference channels. The weight multiplication unit multiplies the M second baseband signals by the M weights corresponding to the respective M reception antennas and then combines resultant signals together to obtain M replicated signals to be supplied to the cancellation unit.

In the description below, when a plurality of components referred to using a reference number XXX are present, the individual components are referred to by adding a suffix A to the reference number as in a reference number XXX-A or a reference number XXX is used as a general term for the components.

### First Embodiment

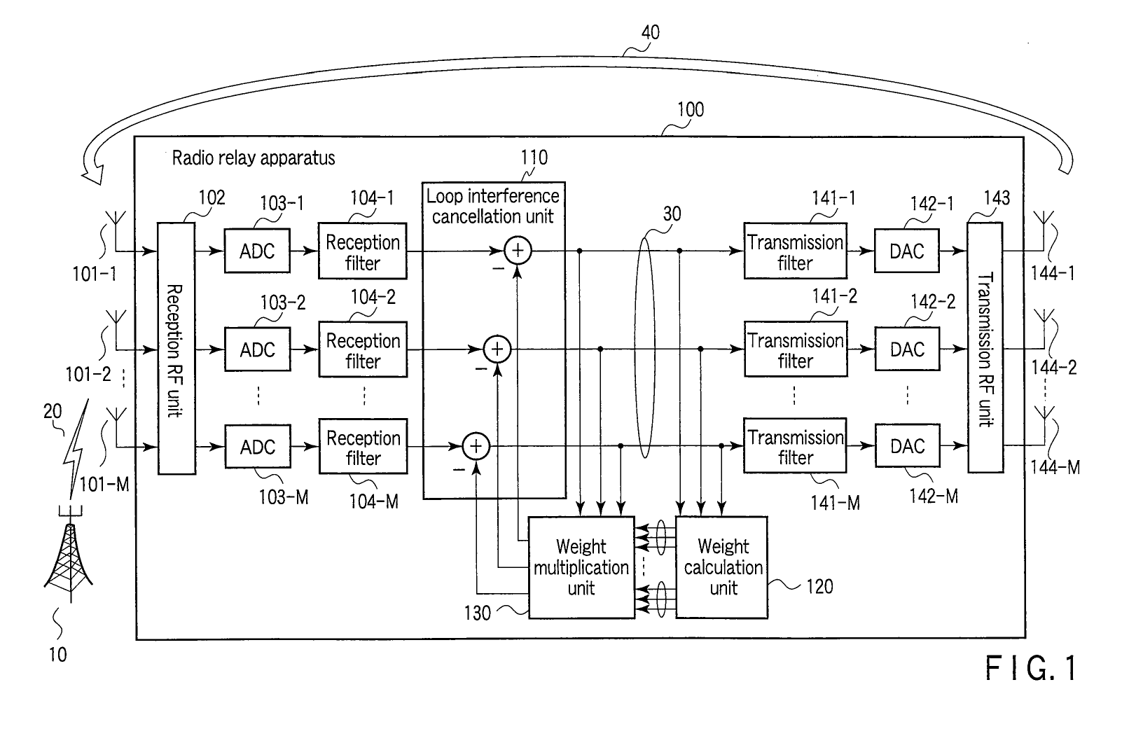

As shown in FIG. 1, a radio relay apparatus 100 according to a first embodiment includes M antennas 101-1, . . . , 101-M (M is an integer of at least 2), a reception radio-frequency (RF) unit 102, M analog-to-digital converters (ADCs) 103-1, . . . , 103-M, M reception filters 104-1, . . . , 104-M, a loop interference cancellation unit 110, a weight calculation unit 120, a weight multiplication unit 130, M transmission filters 141-1, . . . , 141-M, M digital-to-analog converters (DACs) 142-1, . . . , 142-M, transmission RF unit 143, and M transmission antennas 144-1, . . . , 144-M.

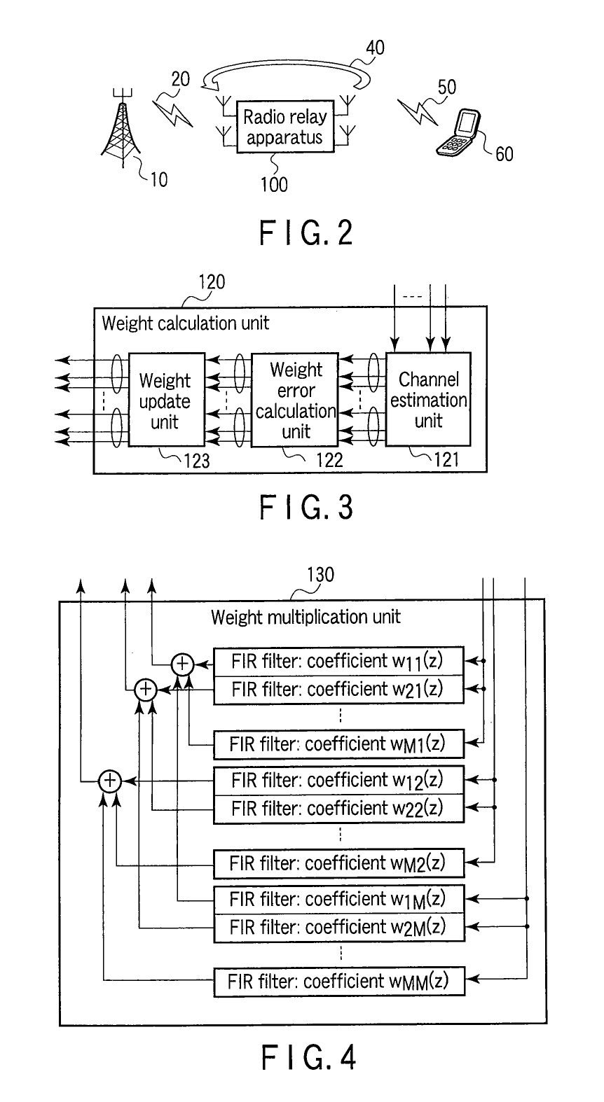

As shown in FIG. 2, in an MIMO communication system, the radio relay apparatus 100 receives a signal from a master station (relay source) 10 via a channel 20. The radio relay apparatus 100 transmits the signal to a slave station (relay destination) via a channel 50. The master station 10 is a radio communication apparatus, for example, a base station or a broadcasting station. The slave station 60 is a radio communication apparatus, for example, user equipment (UE). In the present embodiment, the master station 10 transmits signals in streams that are equal in number to the reception antennas 101 in the radio relay apparatus 100 (that is, M streams).

The reception antennas 101-1, . . . , 101-M receive signals in the respective M streams from the master station 10 via the channel 20. While the radio relay apparatus 100 is relaying the signals, the reception antennas 101-1, . . . , 101-M receive loop interference waves from the transmission antennas 144-1, . . . , 144-M via a loop interference channel 40. That is, the signals received through the reception antennas 101-1, . . . , 101-M include both the signals from the master station 10 and the loop interference signals from the transmission antennas 144-1, . . . , 144-M.

The reception RF unit 102 adjusts the M signals received through the reception antennas 101-1, . . . , 101-M (the adjustment includes filtering and low-noise amplification) to downconvert the signals into M baseband signals.

ADCs 103-1, . . . , 103-M convert the baseband (analog) signals from the reception RF unit 102 into respective digital signals. The reception filters 104-1, . . . , 104-M perform a predetermined filtering process (downsampling and the like) on the digital signals from the respective ADC 103-1, . . . , 103-M.

The loop interference cancellation unit 110 subtracts signals (hereinafter referred to as replicated signals) replicating the loop interference signals in the reception antennas 101-1, . . . , 101-M, from output signals from the reception filters 104-1, . . . , 104-M to cancel the loop interference signals. The replicated signals will be described below in detail. The M output signals from the loop interference cancellation unit 110 are supplied to the transmission filters 141-1, . . . , 141-M and to the weight calculation unit 120 and the weight multiplication unit 130.

The transmission filters 141-1, . . . , 141-M perform a predetermined filtering process on the respective M output signals from the loop interference cancellation unit 110. DACs 142-1, . . . , 142-M convert output (digital) signals from the transmission filters 141-1, . . . , 141-M into analog signals.

The transmission RF unit 143 adjusts the M analog signals from DACs 142-1, . . . , 142-M (the adjustment includes filtering and power amplification) to upconvert the signals into M RF signals.

The transmission antennas 144-1, . . . , 144-M transmit the respective M RF signals from the transmission RF unit 143. The transmission signals are received by the slave stations 60 via the channel 50 and by the reception antennas 141-1, . . . , 141-M via the loop interference channel 40.

The weight calculation unit 120 calculates M×M weights based on the M output signals from the loop interference cancellation unit 110. The M×M weights correspond to M×M channels along which the M output signals from the loop interference cancellation unit 110 loop back to the respective M reception antennas 101-1, . . . , 101-M. The M×M channels may be called as M×M loop interference channels.

The weight multiplication unit 130 multiplies the M output signals from the loop interference cancellation unit 110 by every M of the M×M weights from the weight calculation unit 120 and combine (add) the resultant signals together to obtain M replicated signals. That is, the weight multiplication unit 130 multiplies the M output signals from the loop interference cancellation unit 110 by the M weights corresponding to the M reception antennas 101-1, . . . , 101-M and combines the resultant signals together to obtain M replicated signals to be supplied to the loop interference cancellation unit 110.

The description below involves expressions in order to make the principle of cancellation of loop interference waves according to the present embodiment easily understood. In the analysis below, the signals are equivalently considered to be baseband signals. A transmission signal from the master station 10 is defined as X(z). The transmission signal X(z) is a vector in M rows and one column. In the description below, vectors or matrices are expressed in the form of the number of rows multiplied by the number of columns.

Furthermore, z⁻¹ denotes a delay element for Z-transform. A channel matrix on the channel 20 is defined as B(z). The transmission signal X(z) is multiplied by the channel matrix B(z) when passing through the channel 20. The resultant transmission signal X(z) is received by the reception antenna 101. A channel matrix for the loop interference channel 40 is defined as R(z). The weight by which the weight multiplication unit 130 multiples the output signal is defined as W(z). The channel matrix B(z), the channel matrix R(x), and the weight W(z) are each an M×M matrix. The output signal from the loop interference cancellation unit 110, that is, the signal observed at an observation point 30 is defined as Y(z). The observation signal Y(z) is an M×1 vector. A characteristic of a power amplifier in the transmission RF unit 143 is defined as K. K denotes an M×M diagonal matrix. Here, the observation signal Y(z) can be expressed by:

Y(z)=B(z)·X(z)+R(z)·K·Y(z)+Q(z)·W(z)·Y(z) (1)

The first term on the right side of Expression (1) indicates a component based on the transmission signal from the master station 10. The second term on the right side of Expression (1) indicates a component based on the loop interference wave from each of the transmission antennas 144-1, . . . , 144-M. The third term on the right side of Expression (1) indicates a noise component added to the signal in the radio relay apparatus 100. Q(z) denotes an M×1 vector. The fourth term on the right side of Expression (1) indicates a replicated signal component canceled by the loop interference cancellation unit 110. When an M×M unit matrix is defined as I, Expression (1) can be transformed into:

Y(z)={I−R(z)·K+W(z)}⁻¹·{B(z)·X(z)+Q(z)} (2)

On the other hand, when the channel response of the entire system at the observation point 30 is defined as H(z), an observation signal Y(z) can also be expressed by:

Y(z)=H(z)·X(z) (3)

In Expression (2), it is assumed that the radio relay apparatus has a sufficient signal-to-noise (SN) power ratio. Then, Q(z) is sufficiently small compared to B(z)X(z) and can thus be assumed to be a zero vector. In this case, based on Expressions (2) and (3), the channel response H(z) can also be expressed by:

H(z)={I−R(z)·K+W(z)}⁻¹·B(z) (4)

Here, Expression (4) includes an inverse matrix. Oscillation may result from the use of such a weight as eliminates the inverse matrix. To ensure the presence of the inverse matrix, Expression (5) for the weight W(z) desirably holds true.

W(z)=R(z)·K (5)

Making Expression (5) hold true is equivalent to making an error matrix E(z) defined by Expression (6) a zero matrix.

$$\begin{matrix}E ( z ) = R ( z ) \cdot K - W ( z ) \\ = I - B ( z ) \cdot {H}^{- 1} ( z )\end{matrix} \qquad ( 6 )$$

The channel response H(z) can be derived from the observation signal Y(z) obtained when the transmission signal X(z) is a reference signal (a known signal such as a pilot signal). Furthermore, the channel matrix B(z) can be derived from the observation signal Y(z) when the transmission signal X(z) is a reference signal before relaying is started or while relaying is stopped. Thus, the weight W(z) can be updated using, for example, the error matrix E(z) derived by Expression (6) and also using:

Wₙ(z)=Wₙ(z)+μ·Eₙ(z) (7)

In Expression (7), n denotes a symbol number, and μ denotes a forgetting factor. The initial weight W₀(z) may be a zero matrix. However, if the appropriate weight is known, that known weight may be used.

The weight calculation unit 120 performs calculations related to Expressions (6) and (7). Specifically, as shown in FIG. 3, the weight calculation unit 120 includes a channel estimation unit 121, a weight error calculation unit 122, and a weight update unit 123. The channel estimation unit 121 estimates the channel response H(z) based on the observation signal Y(z) when the transmission signal X(z) is a reference signal. The weight error calculation unit 122 calculates the error matrix E(z) in accordance with Expression (6) using the channel response H(z) from the channel estimation unit 121 and the channel matrix B(z) pre-estimated based on the observation signal Y(z) obtained when the transmission signal X(z) is a reference signal before relaying is started or while relaying is stopped. The channel matrix B(z) may be estimated by the channel estimation unit 121 or by another component (not shown in the drawings). Furthermore, the channel matrix B(z) may be fixed or may be updated during a relaying stopped period. The weight update unit 123 uses the error matrix E(z) from the weight error calculation unit 122 to update the weight W(z) in accordance with Expression (7). The weight update unit 123 inputs the updated weight W(z) to the weight multiplication unit 130. The weight update unit 123 may have a storage function to hold the previously calculated weight W(z) or a function to access storage unit (not shown in the drawings) holding the previously calculated weight W(z).

The weight multiplication unit 130 performs a calculation on the fourth term on the right side of Expression (1). Specifically, as shown in FIG. 4, the weight multiplication unit 130 includes M×M FIR filters and M combiners (adders). Each of the M×M FIR filters multiplies one of the elements of the observation signal Y(z) by one of the elements of the weight W(z). In FIG. 4, a coefficient wᵢⱼ indicates the element in the ith row and jth column of the weight W(z). Here, each of i and j is any natural number equal to or smaller than M. The combiner combines output signals from the FIR filters arranged to perform multiplication of the elements in the columns of the ith row of the weight W(z) to obtain the replicated signal (the replicated signal for the reception antenna 101-i) corresponding to the elements in the ith row of the observation signal Y(z). That is, in order to obtain the replicated signal corresponding to the elements in the ith row of the observation signal Y(z), the weight multiplication unit 130 multiplies the elements in the rows of the observation signal Y(z) by the elements (wᵢ₁, . . . , w_{iM}) in the columns of the ith row and then combines the resultant elements together.

As described above, the radio relay apparatus according to the present embodiment generates replicated signals for loop interference waves in view of the M×M channels along which the M output signals from the loop interference cancellation unit 110 loop back to the respective M reception antennas 101-1, . . . , 101-M. Thus, the radio relay apparatus according to the present embodiment can sufficiently suppress loop interference waves in the MIMO communication system to prevent possible oscillation. That is, the radio relay apparatus according to the present embodiment can achieve stable relaying in the MIMO communication system. A delay element may be provided before the transmission filter so as to appropriately time the actual loop interference wave with the replicated signal corresponding to an output from the FIR filter.

### Second Embodiment

A radio relay apparatus according to the second embodiment is different from the radio relay apparatus 100 according to the first embodiment in that weights are calculated in the frequency domain. In the description below, the same components as those in the first embodiment are denoted by the same reference numbers, and mainly differences from the first embodiment will be described. In each of the embodiments described below, for simplification of description, weights are calculated in the frequency domain. However, of course, weights may be calculated in the time domain.

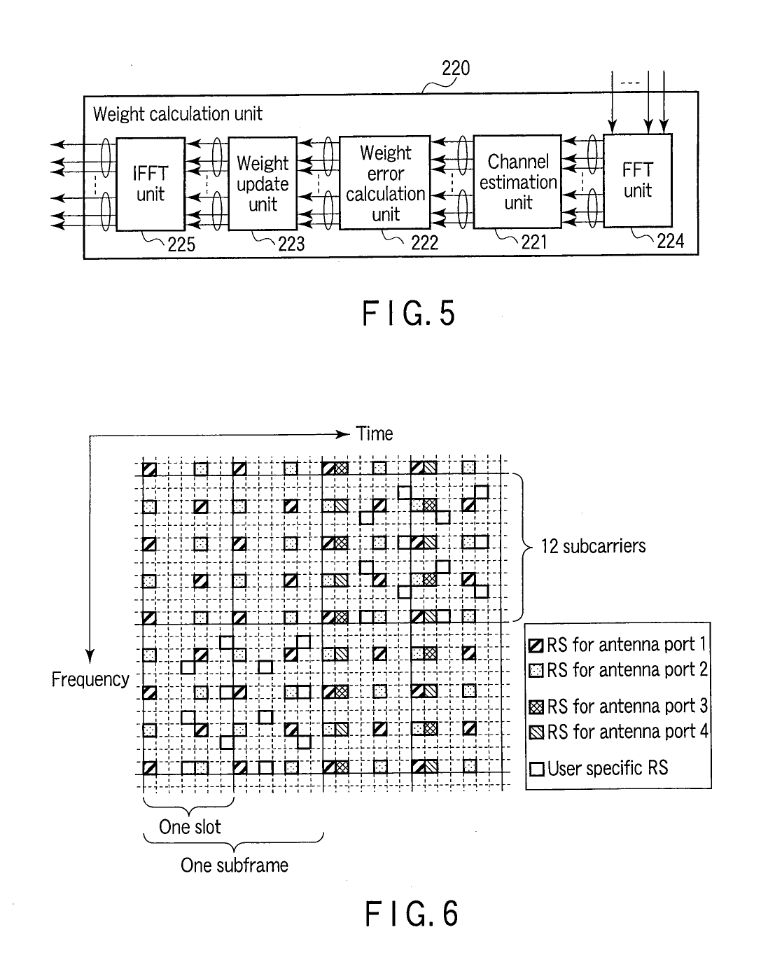

A weight calculation unit 220 according to the present embodiment is shown in FIG. 5. The weight calculation unit 220 includes a fast Fourier transform (FFT) unit 224, a channel estimation unit 221, a weight error calculation unit 222, a weight update unit 223, and an inverse FFT (IFFT) unit 225.

The FFT unit 224 performs FFT on output signals from the loop interference cancellation unit 110, that is, observation signals Y(z). Specifically, the FFT unit 224 provides a buffer function to accumulate a predetermined number of samples of signals (observation signals Y(z)) in the time domain. The FFT unit 224 performs FFT on the accumulated predetermined number of samples. That is, the FFT unit 224 transforms the observation signals Y(z) into observation signals Y(fₖ) in the frequency domain. In the description below, k denotes a sample number in the frequency domain. For orthogonal frequency-division multiplexing (OFDM), k is equivalent to a subcarrier number.

A channel estimation unit 221 estimates the channel response H(fₖ) in the frequency domain based on the observation signal Y(fₖ) in the frequency domain from the FFT unit 224. Here, in the nature of Z-transform, analysis in the frequency domain can be achieved by substituting exp(j2πfT) into z in Expression (1) to Expression (7). Here, j denotes an imaginary unit, f denotes a frequency, and T denotes a sampling interval. For example, Expression (3) can be rewritten as follows in terms of the frequency domain.

Y(fₖ)=H(fₖ)·X(fₖ) (8)

3GPP-LTE uses a frame format shown in FIG. 6. In FIG. 6, a reference signal for an antenna port 1 and a reference signal for an antenna port 2 are constantly transmitted at particular (relative) times and frequencies. A reference signal for an antenna port 3, a reference signal for an antenna port 4, and a user specific reference signal are transmitted as required. As is apparent from FIG. 6, in the frame format LTE, the reference signals (RS) are decimated in a time direction and in a frequency direction. When such a frame format is applied, the channel estimation unit 221 is assumed to use channel estimated values derived from the reference signals to complement channel estimated values for times and frequencies at which no reference signal is present.

A weight error calculation unit 222 uses a pre-estimated channel matrix B(fₖ) and the channel response H(fₖ) from the channel estimation unit 221 to calculate an error matrix E(fₖ) in accordance with:

$$\begin{matrix}E ( {f}_{k} ) = R ( {f}_{k} ) \cdot K - W ( {f}_{k} ) \\ = I - B ( {f}_{k} ) \cdot {H}^{- 1} ( {f}_{k} )\end{matrix} \qquad ( 9 )$$

Expression (9) can be derived by rewriting Expression (6). The channel matrix B(fₖ) may be estimated by the channel estimation unit 221 or by another component (not shown in the drawings). Furthermore, the channel matrix B(fₖ) may be fixed or updated.

A weight update unit 223 uses the error matrix E(z) from the weight error calculation unit 222 to update the weight W(fₖ) in accordance with:

Wₙ₊₁(fₖ)=Wₙ(fₖ)+μ·Eₙ(fₖ) (10)

Expression (10) can be derived by rewriting Expression (7).

The IFFT unit 225 performs IFFT on the weight W(fₖ) from the weight update unit 223. That is, the IFFT unit 225 transforms the weight W(fₖ) in the frequency domain into a weight in the time domain. The size (filter length) of the weight in the time domain increases consistently with the size of IFFT performed by the IFFT unit 225. Thus, the processing may disadvantageously be delayed. Hence, the size of the weight in the time domain may be reduced by decimating or cutting off IFFT output signals as required. The IFFT unit 225 inputs the weight in the time domain to the weight multiplication unit 130.

As described above, the radio relay apparatus according to the present embodiment calculates the weight in the frequency domain. Thus, in, for example, a system using OFDM and a system (such as an uplink in LTE) based on processing in the frequency domain, the radio relay apparatus according to the present embodiment can effectively cancel loop interference waves to prevent possible oscillation. A delay element may be provided before a transmission filter so as to appropriately time the actual loop interference wave with a replicated signal corresponding to an output from an FIR filter.

### Third Embodiment

Each of the above-described embodiments assumes that the number of transmission streams in the master station 10 is identical to that of reception antennas in the radio relay apparatus and to that of transmission antennas in the radio relay apparatus. A third embodiment assumes that the number (N≧1) of transmission streams in the master station 10 is smaller than that (M) of reception antennas in the radio relay apparatus and that (M) of transmission antennas in the radio relay apparatus. That is, in the description below, N<M holds true. As described below, the configuration of the radio relay apparatus according to the present embodiment may be identical or similar to that of the radio relay apparatus 100 according to the first embodiment or the radio relay apparatus according to the second embodiment. Thus, in the description below, the same components as those in each of the above-described embodiments are denoted by the same reference numbers, and mainly differences from the above-described embodiments will be described.

In the present embodiment, Expression (11) can be derived based on the same analysis as that for Expression (1).

Y(fₖ)=B(fₖ)·X(fₖ)+R(fₖ)·K·Y(fₖ)−W(fₖ)·Y(fₖ) (11)

However, Expression (11) corresponds to analysis in the frequency domain and neglects noise components (that is, Q(fₖ) is assumed to be a zero matrix). Here, in the present embodiment, the number of transmission streams is N instead of M used in each of the above-described embodiments. Thus, a transmission signal X(fₖ) indicates an N×1 vector, and a channel matrix B(fₖ) indicates an M×N matrix. In the present embodiment, {I−R(fₖ)·K+W(fₖ)} is an M×M square matrix. Hence, an inverse matrix may be present depending on W(fₖ). That is, Expression (11) can be rewritten as:

H(fₖ)={I−R(fₖ)·K+W(fₖ)}⁻¹·B(fₖ) (12)

As is apparent from Expression (12), in the present embodiment, in order to ensure the presence of an inverse matrix, it is desirable to calculate the weight W(fₖ) so as to make an error matrix E(fₖ) (=W(fₖ)−R(fₖ)·K) a zero matrix, as is the case with each of the above-described embodiments. However, in the present embodiment, a channel response H(fₖ) is an M×N (non-square) matrix. Thus, no inverse matrix is present. Hence, a weight error calculation unit 222 cannot directly derive an error matrix E(fₖ) as shown in:

E(fₖ)·H(fₖ)=H(fₖ)−B(fₖ) (13)

The elements of the channel response H(fₖ) and the channel matrix B(fₖ) can be derived by a technique similar to that in each of the above-described embodiments. For simplification, Expression (14) will be discussed below which is obtained by assuming that in Expression (13), N=1 and M=2.

$$[ \begin{matrix}{e}_{11} ( {f}_{k} ) & {e}_{12} ( {f}_{k} ) \\ {e}_{21} ( {f}_{k} ) & {e}_{22} ( {f}_{k} )\end{matrix} ] \cdot [ \begin{matrix}{h}_{1} ( {f}_{k} ) \\ {h}_{2} ( {f}_{k} )\end{matrix} ] = [ \begin{matrix}{h}_{1} ( {f}_{k} ) \\ {h}_{2} ( {f}_{k} )\end{matrix} ] - [ \begin{matrix}{b}_{1} ( {f}_{k} ) \\ {b}_{2} ( {f}_{k} )\end{matrix} ] \qquad ( 14 )$$

Expression (14) includes four unknown numbers e₁₁(fₖ), . . . , e₂₂(fₖ). On the other hand, two equations can be derived from Expression (14). Thus, e₁₁(fₖ), . . . , e₂₂(fₖ) that meet the two equations cannot be uniquely derived. However, this problem is due to the high degree of freedom of the error matrix E(fₖ). Hence, by setting redundant elements of the error matrix E(fₖ), the weight error calculation unit 222 can uniquely derive the remaining elements. For example, with respect to Expression (14), by setting zero for the non-diagonal components of the error matrix E(fₖ), the weight error calculation unit 222 can uniquely derive the error matrix E(fₖ) as shown in:

$$\{ \begin{matrix}{e}_{11} ( {f}_{k} ) = 1 - \frac{{b}_{1} ( {f}_{k} )}{{h}_{1} ( {f}_{k} )} \\ {e}_{12} ( {f}_{k} ) = 0 \\ {e}_{21} ( {f}_{k} ) = 0 \\ {e}_{22} ( {f}_{k} ) = 1 - \frac{{b}_{2} ( {f}_{k} )}{{h}_{2} ( {f}_{k} )}\end{matrix} \qquad ( 15 )$$

On the other hand, with respect to Expression (14), by setting zero for the diagonal components of the error matrix E(fₖ), the weight error calculation unit 222 can uniquely derive the error matrix E(fₖ) as shown in:

$$\{ \begin{matrix}{e}_{11} ( {f}_{k} ) = 0 \\ {e}_{12} ( {f}_{k} ) = \frac{{h}_{1} ( {f}_{k} ) - {b}_{1} ( {f}_{k} )}{{h}_{2} ( {f}_{k} )} \\ {e}_{21} ( {f}_{k} ) = \frac{{h}_{2} ( {f}_{k} ) - {b}_{2} ( {f}_{k} )}{{h}_{1} ( {f}_{k} )} \\ {e}_{22} ( {f}_{k} ) = 0\end{matrix} \qquad ( 16 )$$

Setting zero for the redundant elements of the error matrix E(fₖ) is equivalent to avoidance of updating the corresponding elements of the weight W(fₖ). Thus, if an initial weight W₀(fₖ) is a zero matrix, the relevant elements of the weight W(fₖ) are fixed to zero. If the weight is fixed to zero, the corresponding FIR filter in a weight multiplication unit 130 may actually perform multiplication by zero or may invalidate an input to or an output from the corresponding FIR filter using, for example, a selector.

The elements of the error matrix E(fₖ) for which zero is set may be optionally selected under a constraint condition. The constraint condition ensures that each of the elements of the error matrix E(fₖ) can be uniquely derived. That is, meeting the constraint condition avoids the situation in which at least one of the elements of the error matrix E(fk) has a plurality of solutions or has no solution. Specifically, the constraint condition that can be adopted is that unknown numbers that are equal in number to transmission streams are left in each of the rows of the error matrix E(fₖ) (in other words, in each of the rows of the error matrix E(fₖ) zero is set for elements that are equal in number to the difference between the number of reception antennas and the number of transmission streams). In order to allow this constraint condition to be easily met, the weight error calculation unit 222 may set zero for the diagonal components of the error matrix E(fₖ) when M−N=1 and for all the non-diagonal components of the error matrix E(fₖ) when N=1.

As described above, the radio relay apparatus according to the present embodiment sets zero for the redundant elements of the error matrix when the number of transmission streams is smaller than that of reception antennas and than that of transmission antennas. The radio relay apparatus according to the present embodiment thus uniquely derives the remaining elements. Thus, when the number of transmission streams is smaller than that of reception antennas and than that of transmission antennas, the radio relay apparatus according to the present embodiment can cancel loop interference waves to prevent possible oscillation using a configuration identical or similar to that of the radio relay apparatus according to each of the above-described embodiments. A delay element may be provided before a transmission filter so as to appropriately time the actual loop interference wave with a replicated signal corresponding to an output from the FIR filter.

Furthermore, in the above description, the number of transmission streams is fixed. However, a system based on MIMO, for example, 3GPP-LTE, is expected to switch between a MIMO mode and a SISO mode or to increase or reduce the number of transmission streams, depending on the status of channels. Thus, the weight error calculation unit 222 desirably provides a function to select redundant elements from the error matrix E(fₖ) in accordance with the increased or reduced number of transmission streams and setting zero for the selected elements. When the weight error calculation unit 222 provides such a function, the radio relay apparatus according to the present embodiment can also effectively cancel loop interference waves in a MIMO communication system with a variable number of transmission streams.

A possible technique avoids operating (M−N) extra transmission and reception systems when the number N of transmission streams is smaller than that M of reception antennas and than that M of transmission antennas. This technique is expected to exert effects substantially equivalent to those of each of the above-described embodiments. However, the technique allows power to concentrate on operating N transmission and reception systems. Thus, in this case, a power amplifier needs to offer higher linearity to cover the same area than in the present embodiment. On the other hand, the radio relay apparatus according to the present embodiment operates more than N transmission and reception systems, thus enabling a reduction in the burden on the power amplifier.

### Fourth Embodiment

A fourth embodiment assumes that the number (M) of reception antennas in a radio relay apparatus is larger than that (N) of transmission streams in a master station 10 and than that (N) of transmission antennas in the radio relay apparatus. That is, in the description below, N<M holds true. In the description below, the same components as those in each of the above-described embodiments are denoted by the same reference numbers, and mainly differences from the above-described embodiments will be described.

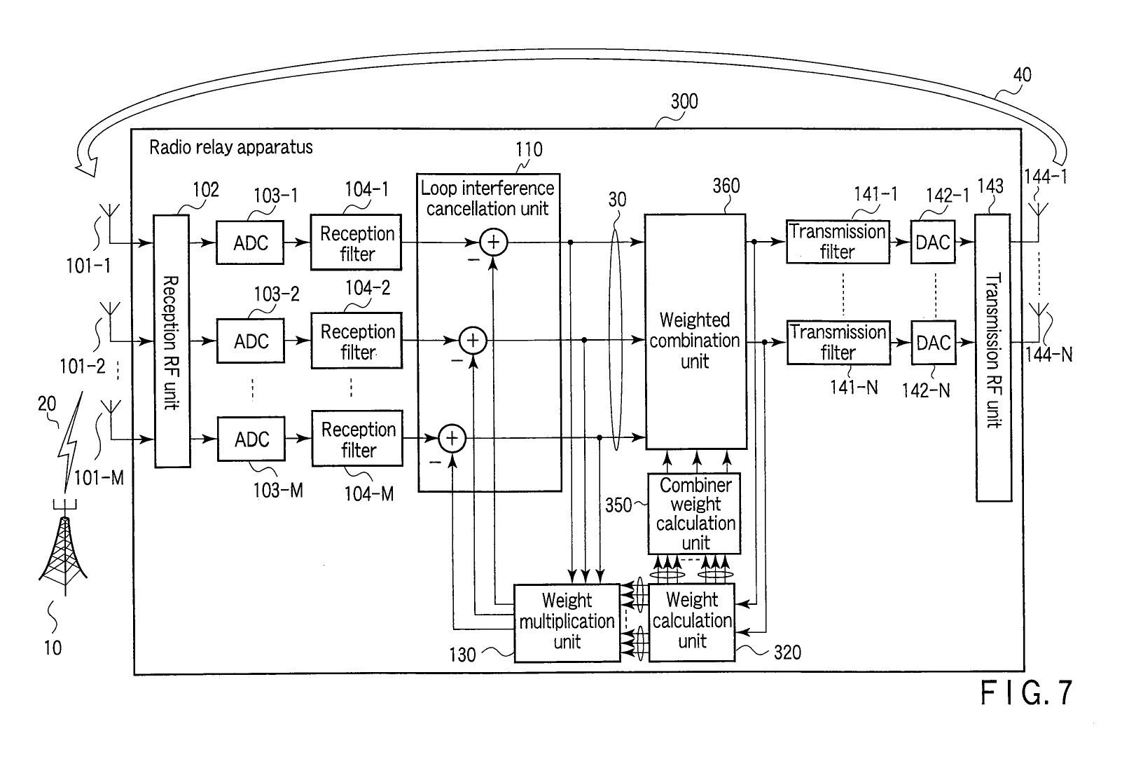

As shown in FIG. 7, a radio relay apparatus 300 according to the present embodiment corresponds to the above-described radio relay apparatus 100 arranged such that the number of transmission systems is changed to N, such that the weight calculation unit 120 is replaced with a weight calculation unit 320, and such that a combiner weight calculation unit 350 and a weighted combination unit 360 are additionally provided.

The weighted combination unit 360 uses a combiner weight from the combiner weight calculation unit 350 to perform weighted combination on M output signals from a loop interference cancellation unit 110, that is, M observation signals, to generate N signals. The combiner weight is an N×M matrix. The combiner weight calculation unit 350 includes, for example, N×M FIR filters and N combiners in order to achieve the weighted combination. The combiner weight calculation unit 350 will be described below.

In the present embodiment, Expression (11) described above can be rewritten as:

$$Y ( {f}_{k} ) = B ( {f}_{k} ) \cdot X ( {f}_{k} ) + R ( {f}_{k} ) \cdot K \cdot G ( {f}_{k} ) \cdot Y ( {f}_{k} ) - W ( {f}_{k} ) \cdot G ( {f}_{k} ) \cdot Y ( {f}_{k} ) \qquad ( 17 )$$

Expression (17) is different from Expression (11) in that in the second term on the right side, which is indicative of a component based on a loop interference wave, an observation signal Y(fₖ) is multiplied by a combiner weight G(fₖ) and in that also in the third term on the right side, which is indicative of a component based on a replicated signal, the observation signal Y(fₖ) is multiplied by the combiner weight G(fₖ). Expression (17) is also different from Expression (11) in that a channel matrix R(fₖ) and a weight W(fₖ) are M×N matrices and in that a characteristic K of a power amplifier is an N×N diagonal matrix. Expression (17) can be rewritten as:

Y(fₖ)=[I−{R(fₖ)·K−W(fₖ)}·G(fₖ)]⁻¹·B(fₖ)·X(fₖ) (18)

When Expression (18) is solved for an error matrix E(fₖ) as is the case with each of the above-described embodiments, Expression (19) can be derived.

$$\begin{matrix}E ( {f}_{k} ) = R ( {f}_{k} ) \cdot K - W ( {f}_{k} ) \\ = \{ H ( {f}_{k} ) - B ( {f}_{k} ) \} \cdot {\{ G ( {f}_{k} ) \cdot H ( {f}_{k} ) \}}^{- 1}\end{matrix} \qquad ( 19 )$$

In Expression (19), the error matrix E(fₖ) and a channel response H(fₖ) are M×N matrices.

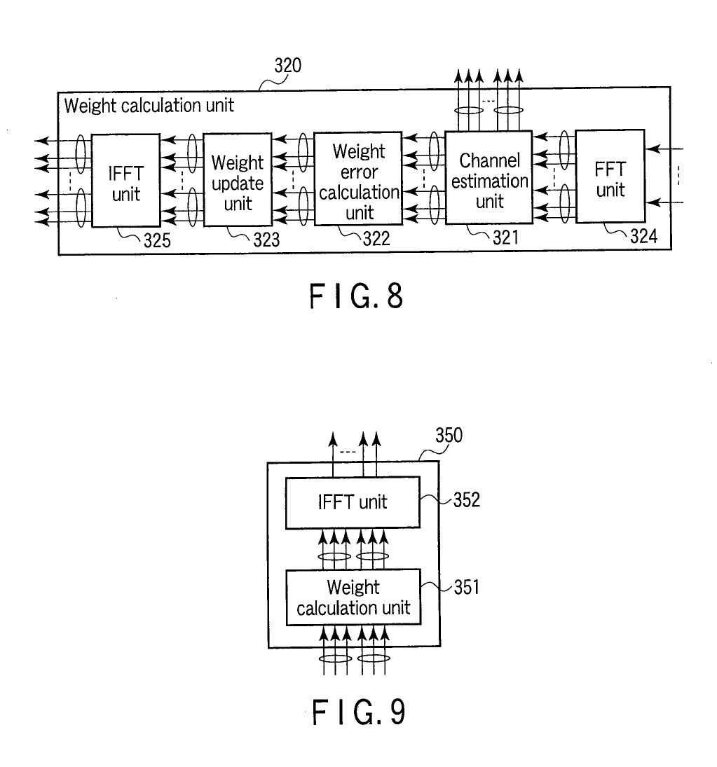

As shown in FIG. 8, the weight calculation unit 320 corresponds to the above-described weight calculation unit 220 in which the FFT unit 224, channel estimation unit 221, weight error calculation unit 222, weight update unit 223, and IFFT unit 225 are replaced with an FFT unit 324, a channel estimation unit 321, a weight error calculation unit 322, a weight update unit 323, and an IFFT unit 325, respectively. The components of the weight calculation unit 320 are similar to those of the weight calculation unit 220. Thus, the description of the same portions as those of the weight calculation unit 220 is omitted, and mainly differences from the weight calculation unit 220 will be described.

The FFT unit 324 performs FFT on N output signals from the weighted combination unit 360. That is, the FFT unit 324 transforms the N output signals from the weighted combination unit 360 into N signals in the frequency domain (corresponding to G(fₖ)·Y(fₖ)).

Based on the N signals in the frequency domain from the FFT unit 324, the channel estimation unit 321 estimates the channel response H(fₖ) in the frequency domain. The channel response H(fₖ) can be estimated by, for example, application of the estimation method according to each of the above-described embodiments. The channel estimation unit 321 inputs the channel response H(fₖ) to both the weight error calculation unit 322 and the combiner weight calculation unit 350.

The weight error calculation unit 322 uses a pre-estimated channel matrix B(fₖ) and the channel response H(fₖ) from the channel estimation unit 321 to calculate an error matrix E(fₖ) in accordance with Expression (19).

The weight update unit 323 uses the error matrix E(fₖ) from the weight error calculation unit 322 to update the weight W(fₖ) in accordance with Expression (10). In the present embodiment, each of the terms in Expression (10) is an M×N matrix.

The IFFT unit 325 performs IFFT on the weight W(fₖ) from the weight update unit 323. That is, the IFFT unit 325 transforms the weight W(fₖ) in the frequency domain into a weight in the time domain. The weight in the time domain is input to the weight multiplication unit 130.

The combiner weight calculation unit 350 includes a weight calculation unit 351 and an IFFT unit 352 as shown in FIG. 9. The weight calculation unit 351 calculates a combiner weight G(fₖ) based on the channel response H(fₖ) from the channel estimation unit 321. The weight calculation unit 351 calculates such a combiner weight G(fₖ) as serves to improve a reception gain based on a standard, for example, a maximum ratio combination standard. The IFFT unit 352 performs IFFT on the combiner weight G(fₖ) from the weight calculation unit 351. That is, the IFFT unit 352 transforms the combiner weight G(fₖ) in the frequency domain into a combiner weight in the time domain. The size (filter length) of the combiner weight in the time domain increases consistently with the size of IFFT performed by the IFFT unit 352. Thus, the processing may disadvantageously be delayed. Hence, the size of the combiner weight in the time domain may be reduced by decimating or cutting off IFFT output signals as required. The IFFT unit 352 inputs the combiner weight in the time domain to the weight multiplication unit 360.

As described above, the present embodiment allows loop interference waves to be cancelled when a configuration is adopted in which the number of transmission antennas is larger than that of reception antennas. Thus, the radio relay apparatus according to the present embodiment enables possible oscillation to be prevented while enjoying the gain of reception diversity. A delay element may be provided before a transmission filter so as to time actual loop interference waves with replicated signals corresponding to outputs from the FIR filters.

### Fifth Embodiment

In a radio relay apparatus according to a fifth embodiment, it is assumed that the apparatus includes two reception antennas and two transmission antennas and that a master station 10 provides one or two transmission streams. More specifically, the present embodiment mainly assumes 3GPP-LTE. However, off course, the radio relay apparatus according to the present embodiment is applicable to radio communication systems other than 3GPP-LTE. In the description below, the same components as those in each of the above-described embodiments are denoted by the same reference numbers, and mainly differences from the above-described embodiments will be described.

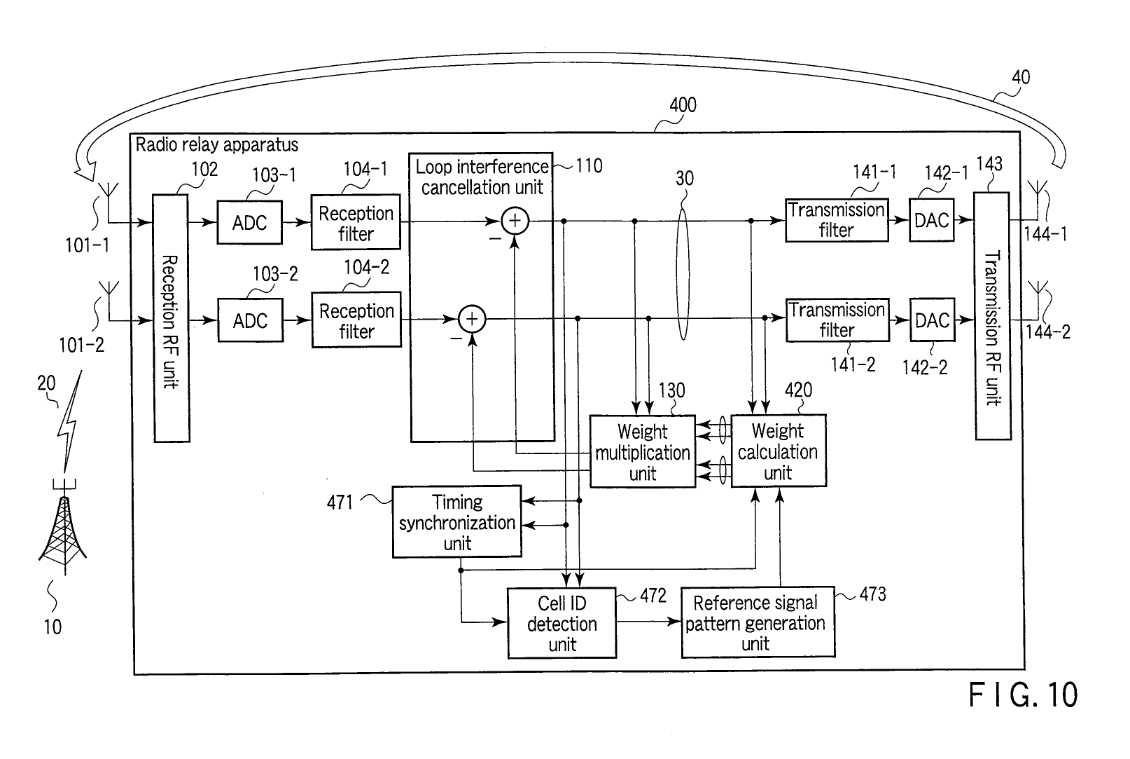

As shown in FIG. 10, a radio relay apparatus 400 according to the present embodiment corresponds to the above-described radio relay apparatus 100 arranged such that the number of transmission and reception systems is set to two, such that the weight calculation unit 120 is replaced with a weight calculation unit 420, and such that a timing synchronization unit 471, a cell ID detection unit 472, and a reference signal pattern generation unit 473 are additionally provided.

The timing synchronization unit 471 detects a synchronization timing and notifies the weight calculation unit 420 of the detected synchronization timing. Specifically, the timing synchronization unit 471 detects the synchronization timing after the radio relay apparatus 400 receives a radio wave from the master station 10 and before relaying is started. FIG. 10 shows an example in which the timing synchronization unit 471 detects the synchronization timing based on an output signal from a loop interference cancellation unit 110. However, since the synchronization timing is detected before the start of the relaying, no loop interference wave occurs at this moment. That is, an input signal to the loop interference cancellation unit 110 is substantially the same as an output signal from the loop interference cancellation unit 110. Hence, of course, the timing synchronization unit 471 may detect the synchronization timing based on the input signal to the loop interference cancellation unit 110. Furthermore, according to the specification of 3GPP-LTE, the timing synchronization unit 471 can detect relevant information on a cell ID together with the synchronization timing. The timing synchronization unit 471 notifies the cell ID detection unit 472 of the relevant information on the cell ID.

The cell ID detection unit 472 detects the cell ID based on the relevant information on the cell ID from the timing synchronization unit 471 and the output signal from the loop interference cancellation unit 110 (or the input signal to the loop interference cancellation unit 110 as described above). The cell ID identifies a cell corresponding to the relay target of the radio relay apparatus 400. The cell ID detection unit 472 notifies the reference signal pattern generation unit 473 of the detected cell ID.

The reference signal pattern generation unit 473 generates a pattern of reference signals corresponding to the cell ID from the cell ID detection unit 472. The reference signal pattern generation unit 473 then inputs the pattern of reference signals to the weight calculation unit 420. Specifically, the reference signal pattern generation unit 473 generates a pattern for the reference signal portion shown in FIG. 6 described above.

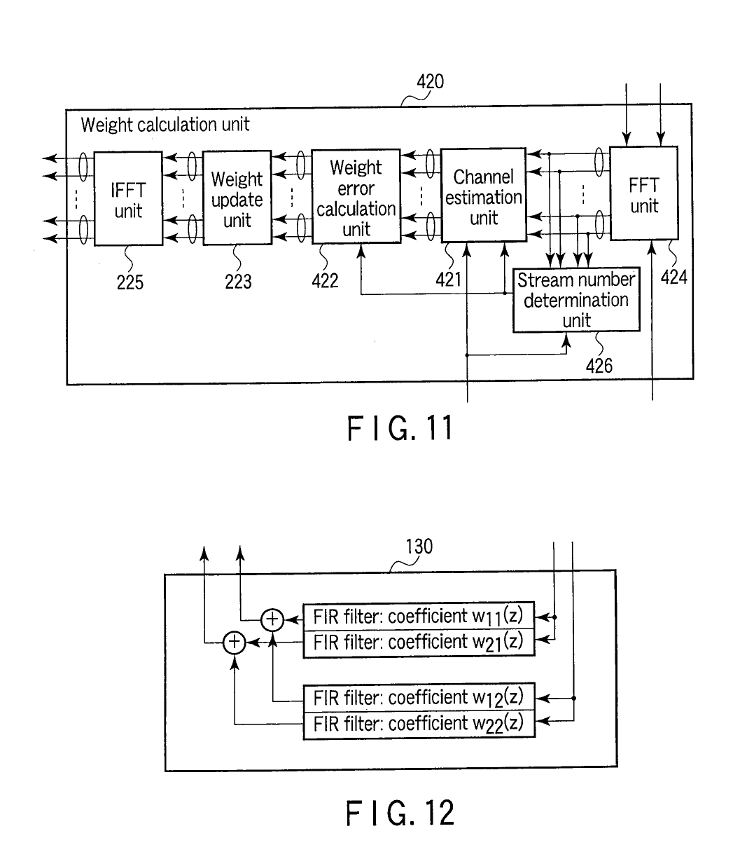

As shown in FIG. 11, the weight calculation unit 420 includes an FFT unit 424, a stream number determination unit 426, a channel estimation unit 421, a weight error calculation unit 422, a weight update unit 223, and an IFFT unit 225. The weight calculation unit 420 calculates a weight in the time domain and then inputs the weight to a weight multiplication unit 130. The weight multiplication unit 130 is arranged such that M=2 in FIG. 4. That is, the weight multiplication unit 130 includes 2×2 FIR filters and two combiners as shown in FIG. 12.

The FFT unit 424 performs basically the same operation as that of the above-described FFT unit 224. However, the timing at which the FFT unit 424 performs FFT is controlled by the synchronization timing from the timing synchronization unit 471.

The stream number determination unit 426 determines the number of transmission streams based on the pattern of reference signals from the reference signal pattern generation unit 473. The stream number determination unit 426 notifies the channel estimation unit 421 and the weight error calculation unit 422 of the determined number of streams. The MIMO communication system is expected to switch between the MIMO mode and the SISO mode or to increase or reduce the number of transmission streams, depending on the status of channels. The stream number determination unit 426 can notify the channel estimation unit 421 and the weight error calculation unit 422 of a change in the number of transmission streams to control the resultant switching of processing. If the relay target is a MIMO communication system with a known and fixed number of transmission streams, the stream number determination unit 426 may be omitted.

The channel estimation unit 421 determines the number of elements in the channel response H(fₖ) in accordance with the number of transmission streams from the stream number determination unit 426. Specifically, when the number of streams=2, the channel response H(fₖ) is expressed by a 2×2 matrix. When the number of streams=1, the channel response H(fₖ) is expressed by a 2×1 vector. The channel estimation unit 421 estimates the channel response H(fₖ) in the frequency domain based on an observation signal Y(fₖ) in the frequency domain from the FFT unit 424 and the pattern of reference signals from the reference signal pattern generation unit 473.

The weight error calculation unit 422 uses the pre-estimated channel matrix B(fₖ) and the channel response H(fₖ) from the channel estimation unit 421 to calculate an error matrix E(fₖ) in accordance with Expression (9) or (13) described above. The weight error calculation unit 422 switches a technique for calculating the error matrix E(fₖ) depending on the number of transmission streams from the stream number determination unit 426. Since the channel response H(fₖ) is a 2×2 matrix (square matrix) when the number of transmission streams=2, the weight error calculation unit 422 calculates the error matrix E(fₖ) in accordance with Expression (9). On the other hand, since the channel response H(fₖ) is a 2×1 vector (non-square matrix) when the number of transmission streams=1, the weight error calculation unit 422 sets zero for redundant elements (for example, diagonal components or non-diagonal components) of the error matrix E(fₖ) and then calculates the remaining elements, in accordance with Expression (13).

As described above, the present embodiment discloses the technique for cancellation loop interference waves when mainly 3GPP-LTE is assumed. The radio relay apparatus according to the present embodiment allows possible oscillation to be prevented in various MIMO communication systems represented by 3GPP-LTE. A delay element may be provided before a transmission filter so as to appropriately time the actual loop interference wave with a replicated signal corresponding to an output from an FIR filter.

### Sixth Embodiment

A sixth embodiment assumes that the number (N) of transmission antennas in a radio relay apparatus is larger than that (M) of transmission streams in a master station 10 and than that (M) of reception antennas in the radio relay apparatus. That is, in the description below, M<N holds true. In the description below, the same components as those in each of the above-described embodiments are denoted by the same reference numbers, and mainly differences from the above-described embodiments will be described.

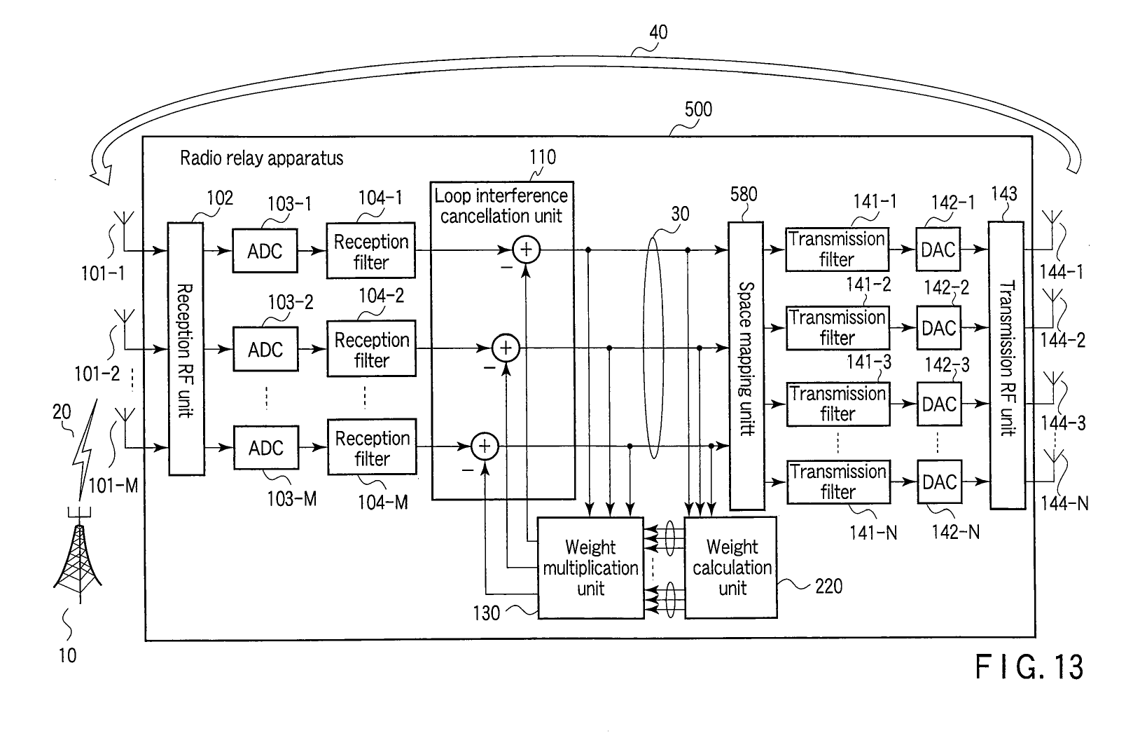

As shown in FIG. 13, a radio relay apparatus 500 according to the present embodiment corresponds to the above-described radio relay apparatus 100 arranged such that the number of transmission and reception systems is changed to N and such that a space mapping unit 580 is additionally provided.

The space mapping unit 580 maps M output signals from the loop interference cancellation unit 110, that is, observation signals, to N signals. The space mapping unit 580 then inputs the N signals to transmission filters 141-1, . . . , 141-N, respectively. Specifically, the space mapping unit 580 multiplies the observation signal Y by a mapping matrix V. The mapping matrix V is an N×M matrix.

In the present embodiment, Expression (11) described above can be rewritten as:

$$Y ( {f}_{k} ) = B ( {f}_{k} ) \cdot X ( {f}_{k} ) + R ( {f}_{k} ) \cdot K \cdot V ( {f}_{k} ) \cdot Y ( {f}_{k} ) - W ( {f}_{k} ) \cdot Y ( {f}_{k} ) \qquad ( 20 )$$

Expression (20) is different from Expression (11) in that in the second term on the right side, which is indicative of a component based on loop interference waves, the observation signal Y(fₖ) is multiplied by the mapping matrix V(fₖ). Expression (20) is also different from Expression (11) in the following points: a channel matrix B(fₖ) is an M×M matrix, a transmission signal X(fₖ) is an M×1 vector, a channel matrix R(fₖ) is an M×N matrix, and a characteristic K of a power amplifier is an N×N diagonal matrix. Expression (20) can be rewritten as:

Y(fₖ)=[I−{R(fₖ)·K·V(fₖ)−W(fₖ)}]⁻¹·B(fₖ) (21)

When Expression (21) is solved for an error matrix E(fₖ) as is the case with each of the above-described embodiments, Expression (22) can be derived.

$$\begin{matrix}E ( {f}_{k} ) = R ( {f}_{k} ) \cdot K \cdot V ( {f}_{k} ) - W ( {f}_{k} ) \\ = I - B ( {f}_{k} ) \cdot {H ( {f}_{k} )}^{- 1}\end{matrix} \qquad ( 22 )$$

In Expression (22), the error matrix E(fₖ) and a channel response H(fₖ) are M×M matrices. As is apparent from Expression (22), the error matrix E(fₖ) is independent of the mapping matrix V(fₖ). For example, the mapping matrix V may be determined based on a channel 50 from the radio relay apparatus 500 to a slave station (relay destination) 60 or may be a fixed matrix independent of frequencies.

As described above, the present embodiment allows loop interference waves to be cancelled when a configuration is adopted in which the number of transmission antennas is larger than that of reception antennas. Thus, the radio relay apparatus according to the present embodiment enables possible oscillation to be prevented while enjoying the gain of transmission diversity. A delay element may be provided before a transmission filter so as to appropriately time the actual loop interference wave with a replicated signal corresponding to an output from an FIR filter.

Each of the embodiments can be implemented as any of various radio communication apparatuses such as relay stations and gap fillers which are assumed to perform relaying. Furthermore, each of the embodiments is applicable not only to 3GPP-LTE but also to various MIMO communication systems. For example, each of the embodiments is applicable to WiMAX, next-generation PHS (XGP), cdma2000 EV-DO Advanced, and the like.

For example, a program can be provided which is stored in a computer readable storage medium and configured to implement the processing according to each of the embodiments. The storage medium may be in any storage format provided that the program can be stored in the storage medium and read from the storage medium by a computer; the storage medium may be a magnetic disk, an optical disc (CD-ROM, CD-R, DVD, or the like), a magneto-optical disk (MO or the like), a semiconductor memory, or the like.

Furthermore, the program configured to implement the processing according to each of the embodiments may be stored in a computer (server) connected to a network such as the Internet. Thus, the program may be downloaded into a computer (client) via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radio relay apparatus which receives a target signal with N (N≧1) streams from a first radio communication apparatus via M (M≧2) reception antennas and transmits the target signal to a second radio communication apparatus via M transmission antennas, the radio relay apparatus comprising:
a reception unit configured to generate M first baseband signals based on M first RF signals supplied by the M reception antennas;
a cancellation unit configured to subtract M replicated signals replicating loop interference signals in the M reception antennas, from the respective M first baseband signals, to obtain M second baseband signals;
a transmission unit configured to generate M second RF signals based on the M second baseband signals and to supply the M second RF signals to the M transmission antennas, respectively;
a weight calculation unit configured to calculate M×M weights corresponding to M×M loop interference channels; and
a weight multiplication unit configured to multiply the M second baseband signals by the M weights corresponding to the respective M reception antennas and then to combine resultant signals together to obtain M replicated signals to be supplied to the cancellation unit.

2. The apparatus according to claim 1, wherein the weight calculation unit includes:
an FFT unit configured to perform fast Fourier transform (FFT) on the M second baseband signals to obtain M signals in a frequency domain;
a channel estimation unit configured to perform channel estimation based on the M signals in the frequency domain and known reference signals;
an error calculation unit configured to calculate M×M errors with respect to ideal M×M weights for previously calculated M×M weights based on a result of the channel estimation;
an update unit configured to update the previously calculated M×M weights in such a manner that each of the M×M errors approaches zero to obtain updated M×M weights;
an IFFT unit configured to perform inverse fast Fourier transform (IFFT) on the updated M×M weight to obtain M×M weights in a time domain and to supply the obtained M×M weights to the weight multiplication unit.

3. The apparatus according to claim 2, wherein when N<M, the error calculation unit sets zero for M×(M−N) of the M×M errors and calculates remaining M×N errors.

4. The apparatus according to claim 3, further comprising:
a synchronization unit configured to detect a synchronization timing and relevant information on a cell ID based on either the M first baseband signals or the M second baseband signals before the target signal is transmitted to the second radio communication apparatus;
a detection unit configured to detect a cell ID based on the relevant information on the cell ID and either the M first baseband signals or the M second baseband signals; and
a generation unit configured to generate a pattern of the reference signals in accordance with the cell ID; and
wherein the FFT unit performs the FFT in accordance with the synchronization timing.

5. The apparatus according to claim 4, further comprising a determination unit configured to determine the number of streams based on the pattern of the reference signals.

6. A radio relay apparatus which receives a target signal with N (N≧2) streams from a first radio communication apparatus via M (M>N) reception antennas and transmits the target signal to a second radio communication apparatus via N transmission antennas, the radio relay apparatus comprising:
a reception unit configured to generate M first baseband signals based on M first RF signals supplied by the M reception antennas;
a cancellation unit configured to subtract M replicated signals replicating loop interference signals in the M reception antennas, from the respective M first baseband signals, to obtain M second baseband signals;
a weighted combination unit configured to perform weighted combination on the M second baseband signals using N×M combiner weights, to obtain N third baseband signals;
a transmission unit configured to generate N second RF signals based on the N third baseband signals and to supply the N second RF signals to the N transmission antennas, respectively;
a weight calculation unit configured to calculate M×N weights corresponding to M×N loop interference channels; and
a weight multiplication unit configured to multiply the N third baseband signals by the N weights corresponding to the respective M reception antennas and then to combine resultant signals together to obtain M replicated signals to be supplied to the cancellation unit.

7. A radio relay apparatus which receives a target signal with M (M≧2) streams from a first radio communication apparatus via M reception antennas and transmits the target signal to a second radio communication apparatus via N (N>M) transmission antennas, the radio relay apparatus comprising:
a reception unit configured to generate M first baseband signals based on M first RF signals supplied by the M reception antennas;
a cancellation unit configured to subtract M replicated signals replicating loop interference signals in the M reception antennas, from the respective M first baseband signals, to obtain M second baseband signals;
a mapping unit configured to map the M second baseband signals to N third baseband signals;
a transmission unit configured to generate N second RF signals based on the N third baseband signals and to supply the N second RF signals to the N transmission antennas, respectively;
a weight calculation unit configured to calculate M×M weights corresponding to M×M loop interference channels; and
a weight multiplication unit configured to multiply the M second baseband signals by the M weights corresponding to the respective M reception antennas and then to combine resultant signals together to obtain M replicated signals to be supplied to the cancellation unit.
